(19) United States
(12) Patent Application Publication
(10) Pub. No.: US 2017/0346046 A1
(43) Pub. Date: Nov. 30, 2017

(54) ELECTROCHEMICAL DEVICE

(71) Applicant: LG Chem, Ltd., Seoul (KR)

(72) Inventor: Joo-Yong Song, Daejeon (KR)

(73) Assignee: LG Chem, Ltd., Seoul (KR)

(21) Appl. No.: 15/535,577

(22) PCT Filed: Dec. 28, 2015
(86) PCT No.: PCT/KR2015/014358

§ 371 Date: Jun. 13, 2017

(30) Foreign Application Priority Data
Dec. 26, 2014 (KR) 10-2014-0191038

(51) Int. Cl. H01M 2/02; H01M 2/34; H01M 10/04; H01M 10/052

(52) U.S. Cl. CPC H01M 2/02; H01M 10/052; H01M 2/34; H01M 10/04

(57) ABSTRACT

The electrochemical device of the present disclosure includes a case, an electrode assembly disposed inside the case, and including a positive electrode and a negative electrode and a separator interposed between the positive electrode and the negative electrode, and an electrolyte injected inside the case, and a free space volume (EV) according to Equation 2 below with respect to a total volume of empty space inside the case (CV) according to Equation 1 below is 0 to 45 volume%. The contents of Equation 1 and Equation 2 are the same as disclosed in the present specification.

The electrochemical device is capable of solving the problem where gas generated by oxidation reaction of electrolyte due to high-voltage reduces reaction surface area of an electrode surface, and further increases side reaction, thereby accelerating degradation of capacity.

### TECHNICAL FIELD

The present application claims priority to Korean Patent Application No. 10-2014-0191038 filed on Dec. 26, 2014 in the Republic of Korea, the disclosures of which are incorporated herein by reference.

The present disclosure relates to an electrochemical device, and more particularly, to providing an electrochemical device capable of solving the problem where gas generated by oxidation reaction of electrolyte due to high-voltage reduces reaction surface area of an electrode surface, and further increases side reaction, thereby accelerating degradation of capacity.

### BACKGROUND ART

Importance of lithium secondary batteries (for example, lithium ion batteries), nickel hydrogen batteries and other secondary batteries as power source that may be mounted onto vehicles, or power source for portable terminals such as notebooks and the like is increasing. Especially, a lithium secondary battery capable of obtaining high energy density even when it is light weighted may preferably be used as a high output power source to be mounted onto vehicles, and thus its demand is expected to continue increasing in the future.

However, since such a high power lithium secondary battery operates under high-voltage, there occurs a problem where oxidation reaction of electrolyte generates a large amount of gas. In order to prevent the problem of battery expansion due to such generation of gas, U.S. Pat. No. 7,223,502 discloses a technology of reducing generation of gas using an electrolyte including carboxylic acid ester having an unsaturated bond and a sulfonic compound.

Further, Korean Laid-open Patent No. 2011-0083970 also discloses a technology of using an electrolyte having a compound that includes difluorotoluene having a low oxidation potential in order to prevent the phenomenon of the electrolyte being decomposed in a high-voltage state so that batteries do not expand.

Meanwhile, Korean Patent Registration No. 0760763 relates to an electrolyte for a high-voltage lithium secondary battery, a technology of preventing the electrolyte from being decomposed by using as an additive the electrolyte including halogenated biphenyl and di-halogenated toluene of which the oxidation reaction potential is within a range of 4.6 to 5.0V in order to secure stability during overcharging of the lithium secondary battery. Further, Japanese Laid-open Patent No. 2005-135906 relates to a lithium secondary battery including a non-aqueous electrolyte having excellent charging and discharging characteristics, a technology of adding an overcharge inhibitor in order to stabilize the performance of battery at high-voltage.

However, the aforementioned technologies do not at all recognize the problem where the gas generated by oxidation reaction of the electrolyte due to high-voltage may reduce the reaction surface area of the electrode surface, and further increase the side reaction, thereby accelerating capacity degradation, nor do they suggest any solutions to that.

### PRIOR ART DOCUMENTS

### Patents

U.S. Pat. No. 7,223,502 (Registered on May 29, 2007)

Korean Laid-open Patent No. 2011-0083970 (Laid-open on Jul. 21, 2011)

Korean Patent Registration No. 0760763 (Registered on Sep. 14, 2007)

Japanese Laid-open Patent No. 2005-135906 (Laid-open on May 26, 2005)

### DISCLOSURE

### Technical Problem

The present disclosure is designed to solve the problems of the related art, and therefore the present disclosure is directed to providing an electrochemical device capable of solving the problem where gas generated by oxidation reaction of electrolyte due to high-voltage reduces reaction surface area of an electrode surface, and further increases side reaction, thereby accelerating degradation of capacity. These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

### Technical Solution

The present disclosure relates to an electrochemical device for solving the aforementioned technical problem.

In a first aspect of the present disclosure, there is provided an electrochemical device, the electrochemical device including a case, an electrode assembly disposed inside the case, and including a positive electrode and a negative electrode and a separator interposed between the positive electrode and the negative electrode, a cap assembly coupled to an open top end of the case and provided with a current interrupt device (CID), and an electrolyte injected inside the case. Here, the negative electrode includes a carbon material as a negative electrode active material. Further, in the electrochemical device, a volume of free space (EV) according to Equation 2 below with respect to a total volume of empty space inside the case (CV) according to Equation 1 below is 0 to 45 volume %.

Volume of empty space inside the case (CV)=total volume inside the case (AV)−volume of electrode assembly (BV) [Equation 1]

Volume of free space (EV)=volume of empty space inside the case (CV)−volume of electrolyte (DV) [Equation 2]

In a second aspect of the present disclosure according to the first aspect, the electrochemical device is a cylindrical-type electrochemical device.

In a third aspect of the present disclosure according to the first or second aspect, the volume of free space (EV) with respect to the total volume of empty space inside the case (CV) is 5 to 30 volume %.

In a fourth aspect of the present disclosure according to any one of the first to third aspects, the volume of the electrolyte (DV) is 55 to 100 volume % with respect to the total volume of empty space inside the case (CV).

In a fifth aspect of the present disclosure according to any one of the first to fourth aspects, the volume of the electrolyte (DV) is 0.5 to 10 cm³.

In a sixth aspect of the present disclosure according to any one of the first to fifth aspects, in a state where the electrochemical device is charged by 1C (C rate) and discharged by 1C at 25° C., and having the charging and discharging as 1 cycle, the cycle is iterated 100 times, when the volume of free space (EV) is 0 to 45 volume %, a pressure inside the case is 1.5 to 15 times the pressure inside the case when the volume of free space (EV) exceeds 45 volume %.

In a seventh aspect of the present disclosure according to any one of the first to sixth aspects, in a state where the electrochemical device is charged by 1C and discharged by 1C at 25° C., and having the charging and discharging as 1 cycle, the cycle is iterated 100 times, a pressure inside the case is 1 to 15 kgf/cm².

In an eighth aspect of the present disclosure according to any one of the first to seventh aspects, the positive electrode includes any one positive electrode active material selected from a group consisting of LiNi_{1-y}Mn_{y}O₂(O<y<1), LiMn_{2-z}Ni_{z}O₄(0<z<2) and a mixture thereof.

In a ninth aspect of the present disclosure according to any one of the first to eighth aspects, the electrochemical device is a high-voltage electrochemical device of 3V or more.

In a tenth aspect of the present disclosure according to any one of the first to ninth aspects,

the electrochemical device is a lithium secondary battery.

In an eleventh aspect of the present disclosure according to any one of the first to tenth aspects, the current interrupt device (CID) has a short-circuit pressure of 13 kgf/cm² to 20 kgf/cm².

In a twelfth aspect of the present disclosure according to any one of the first to eleventh aspects, the current interrupt device (CID) has a short-circuit pressure of 13 kgf/cm² to 20 kgf/cm², and when fully charged and stored at a constant temperature condition of 75° C., short-circuit occurs for 600 hours or more.

In a thirteenth aspect of the present disclosure according to the eleventh aspect, the current interrupt device (CID) has a short-circuit pressure of 13 kgf/cm² to 20 kgf/cm², and of the range, the short-circuit pressure is set higher than an inner pressure in a state where when the electrochemical device is charged by 1C and discharged by 1C at 25° C., and having the charging and discharging as 1 cycle, the cycle is iterated 100 times.

### Advantageous Effects

The present disclosure gives the following effects. The present disclosure is capable of solving the problem where gas generated by oxidation reaction of electrolyte due to high-voltage reduces reaction surface area of an electrode surface, and further increases side reaction, thereby accelerating degradation of capacity.

### DESCRIPTION OF DRAWINGS

Other objects and aspects of the present disclosure will become apparent from the following descriptions of the embodiments with reference to the accompanying drawings in which:

The accompanying drawings illustrate a preferred embodiment of the present disclosure and together with the foregoing disclosure, serve to provide further understanding of the technical spirit of the present disclosure, and thus, the present disclosure is not construed as being limited to the drawing.

FIG. 1 is an exploded perspective view of a lithium secondary battery according to an embodiment of the present disclosure.

FIG. 2 is an enlarged view of a cap assembly portion of a lithium secondary battery according to an embodiment of the present disclosure.

FIG. 3 is a view mimetically illustrating the capacity degradation caused by generation of gas in a conventional lithium secondary battery.

FIG. 4 is a view illustrating the principle where the speed of capacity degradation decreases in the present disclosure.

FIG. 5 is a graph illustrating lifespan characteristics of a lithium secondary battery fabricated in Examples and Comparative Examples of the present disclosure.

### BEST MODE

Hereinafter, embodiments of the present disclosure will be explained in detail with reference to the drawings attached so that one skilled in the related art of the present disclosure can easily carry out. However, the present disclosure may be realized in various different forms, and is not limited to the embodiments explained here.

Terms used in the present disclosure are used merely to explain certain embodiments, not to limit the present disclosure. Singular expressions include plural expressions unless clearly mentioned otherwise in the context. It should be understood that, in the present disclosure, terms such as ‘include/comprise’ or ‘have/has’ and so on are intended to designate existence of a characteristic, a number, a step, an operation, an element, a component or a combination thereof disclosed in the present specification, not to exclude beforehand possibility of existence or addition of one or more other characteristics, numbers, steps, operations, elements, components or combinations thereof.

An electrochemical device according to an embodiment of the present disclosure includes a case, an electrode assembly disposed inside the case, and including a positive electrode and a negative electrode and a separator interposed between the positive electrode and the negative electrode, and an electrolyte injected inside the case.

The electrochemical device includes all devices that perform electrochemical reactions, specifically for example, all types of primary and secondary batteries, fuel cells, solar cells, or capacitors such as super capacitor devices, etc.

Hereinafter, more detailed explanation will be made on a case where the electrochemical device is a lithium secondary battery. The lithium secondary batteries may be classified into lithium ion batteries, lithium ion polymer batteries and lithium polymer batteries depending on the type of separator and electrolyte used, into cylindrical-type, prismatic-type, coin-type, pouch-type and the like depending on the form thereof, and into bulk type and thin film type depending on the size thereof.

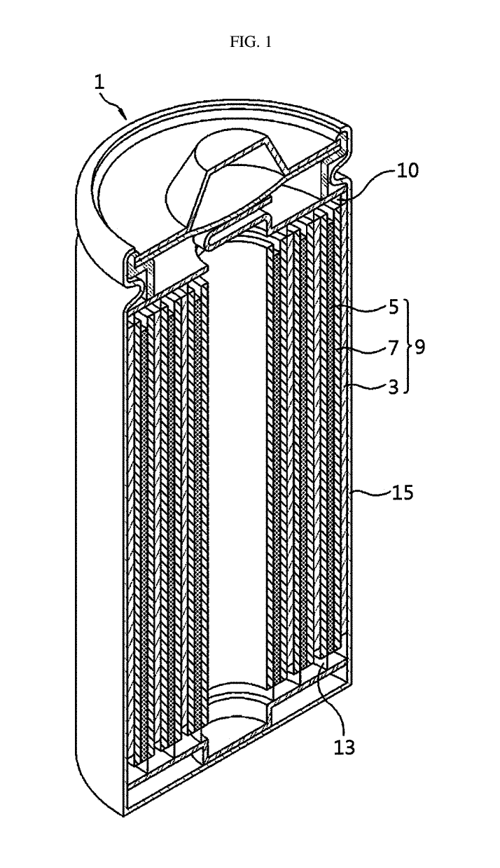

FIG. 1 is an exploded perspective view of a lithium secondary battery 1 according to another embodiment of the present disclosure. Referring to FIG. 1, the lithium secondary battery 1 may be fabricated by arranging a negative electrode 3, a positive electrode 5, and a separator 7 between the negative electrode 3 and the positive electrode 5 to fabricate an electrode assembly 9, and disposing the electrode assembly 9 in a case 15 and injecting electrolyte (not illustrated) therein so that the negative electrode 3, the positive electrode 5 and the separator 7 are impregnated in the electrolyte.

To each of the negative electrode 3 and the positive electrode 5, a conductive lead member 10, 13 for collecting current that is generated when the battery is acting may be attached, and the conductive lead member 10, 13 may induce the current generated in each of the positive electrode 5 and the negative electrode 3 to a positive electrode terminal and a negative electrode terminal.

The negative electrode 3 may be fabricated by mixing a negative electrode active material, a binder and selectively a conductive material to fabricate a composition for forming a negative electrode active material layer, and applying this composition to a negative electrode current collector such as copper foil and the like.

Further, according to a specific embodiment aspect of the present disclosure, the secondary battery according to the present disclosure is provided with a cap assembly 20 coupled to an open top end of the battery case, a beading unit 40 prepared at a front end of the battery case 15 in order to mount the cap assembly 20, and a crimping portion 50 for sealing the battery. In the present disclosure, to the positive electrode, a positive electrode lead 10 is attached, and connected to the cap assembly 20, and to the negative electrode, a negative electrode lead 13 is attached, and connected to a lower end of the battery case 15.

As the negative electrode active material, a compound capable of reversible intercalation and de-intercalation of lithium may be used. Specific examples of the negative electrode active material include carbon materials such as artificial graphite, graphite, natural graphite, graphitized carbon fiber, and amorphous carbon, etc. Further, besides the aforementioned carbon materials, a metallic compound that can be alloyed with lithium, or a composite including a metallic compound and a carbon material may be additionally included as the negative electrode active material.

The metal that can be alloyed with lithium may be at least one of Si, Al, Sn, Pb, Zn, Bi, In, Mg, Ga, Cd, Si alloy, Sn alloy and Al alloy. Further, as the negative electrode active material, a metal lithium thin film may be used. The negative electrode active material may be any one selected from a group consisting of crystalline carbon, non-crystalline carbon, carbon composite, lithium metal, alloy including lithium and a mixture thereof, since these are highly stable materials.

Further, according to a specific embodiment aspect of the present disclosure, lithium titan oxide (LTO) may be included as the negative electrode active material. Recently, the lithium titan oxide is used more frequently as a negative electrode active material. Compared to carbon materials such as graphite, as a negative electrode active material, the lithium titan oxide is capable of high speed charging and discharging due to the excellent mobility of lithium ions, and has almost no irreversible reaction (with a capacity retention ratio of 95% compared to initial efficiency) and an extremely low reaction heat, thereby providing an advantage of excellent stability.

Non-restrictive examples of the lithium titan oxide include one or more selected from Li_{0.8}Ti_{2.2}O₄, Li_{2.67}Ti_{1.33}O₄, LiTi₂O₄, Li_{1.33}Ti_{1.67}O₄, and Li_{1.14}Ti_{1.71}O₄, but there is no limitation thereto.

The binder plays a role of attaching electrode active material particles well to one another, or attaching electrode active material to a current collector well, and specific examples of the binder include polyvinylidene fluoride (PVDF), polyvinyl alcohol, carboxymethyl cellulose (CMC), starch, hydroxypropyl cellulose, recycled cellulose, polyvinyl pyrrolidone, tetrafluoro ethylene, polyethylene, polypropylene, ethylene-propylene-dien polymer (EPDM), sulfonated-EPDM, styrene-butadiene rubber, fluoro rubber and various copolymers thereof, etc.

Further, preferred examples of the solvent include dimethyl sulfoxide (DMSO), alcohol, N-methyl pyrrolidone (NMP), acetone or water, etc.

The current collector may be any one metal selected from a group consisting of copper, aluminum, stainless steel, titanium, silver, palladium, nickel, an alloy thereof, and a combination thereof, and the stainless steel may be surface-treated with carbon, nickel, titan or silver, and the alloy may preferably be aluminum-cadmium alloy, and besides these, a plasticized carbon, a nonconductive polymer with a surface treated with a conductive material, or a conductive polymer and the like may be used.

The conductive material is a material used to provide conductivity to the electrode, and any material may be used as long as it is an electronic conductive material that does not cause chemical changes in the battery being formed, for example, metal powder, metal fiber and the like of natural graphite, artificial graphite, carbon black, acetylene black, ketjen black, carbon fiber, copper, nickel, aluminum, silver and the like, or a mixture of one type or one or more types of conductive materials such as a polyphenylene derivative, etc.

The method for applying the aforementioned fabricated composition for forming a negative electrode active material layer to the current collector may be selected from well-known methods or a new appropriate method may be performed in consideration of the characteristics of the materials and the like. For example, it is preferable to distribute the composition for forming a negative electrode active material layer on top of the current collector and then uniformly disperse the same using a doctor blade and the like. In some cases, a method of performing distributing and dispersing in one process may be used. Besides the aforementioned, methods such as die casting, comma coating, screen printing and the like may be used.

Just as the negative electrode 3, the positive electrode 5 may be fabricated by mixing a positive electrode active material, a conductive material, and a binder to fabricate a composition for forming a positive electrode active material layer, and then applying the composition for forming a positive electrode active material layer on a positive electrode current collector such as an aluminum foil and the like, and then rolling the same.

As the positive electrode active material, a compound capable of reversible intercalation and de-intercalation of lithium (lithiated intercalation compound) may be used. Specifically, a lithium containing transition metal oxide may preferably be used, and for example, any one selected from a group consisting of LiCoO₂, LiNiO₂, LiMnO₂, LiMn₂O₄, Li(NiₐCo_{b}Mn_{c})O₂(0<a<1, 0<b<1, 0<c<1, a+b+c=1), LiNi_{1-y}Co_{y}O₂, LiCo_{1-y}Mn_{y}O₂, LiNi_{1-y}Mn_{y}O₂(O≦y<1), Li(NiₐCo_{b}Mn_{c})O₄(0<a<2, 0<b<2, 0<c<2, a+b+c=2), LiMn_{2-z}Ni_{z}O₄, LiMn_{2-z}Co_{z}O₄(0<z<2), LiCoPO₄ and LiFePO₄, or a mixture of two or more types selected therefrom may be used. Further, besides the aforementioned oxides, sulfides, selenides, halides and the like may also be used.

If the lithium titan oxide is used as the negative electrode active material, the lithium titan oxide will have an operating voltage ranging from 1.3 to 1.6V(vs. Li/Li+), and thus in order to fabricate a high-voltage battery, it is preferable to use a relatively high potential positive electrode.

In the present disclosure, there is no special limitation to the high potential positive electrode that may be used regarding the lithium titan oxide negative electrode active material, but preferably, any positive electrode material may be used without limitation as long as it forms an electrochemical device capable of representing a nominal voltage of 2.0 to 3.5V regarding the lithium titan oxide negative electrode active material, and as such a positive electrode active material, any one positive electrode active material selected from a group consisting of LiNi_{1-y}Mn_{y}O₂(O<y<1), LiMn_{2-z}Ni_{z}O₄(0<z<2) and a mixture thereof may preferably be used.

The electrolyte may include an organic solvent and lithium salt.

There is no particular limitation to the organic solvent as long as it can serve as a medium where ions involved in the electrochemical reaction of the battery can move. Specifically, the organic solvent may be ester solvent, ether solvent, ketone solvent, aromatic hydrocarbon solvent, alkoxyalkane solvent, carbonate solvent or the like, or one type thereof that is used solely, or two or more types thereof that are mixed and used.

Specific examples of the ester solvent include methyl acetate, ethyl acetate, n-propyl acetate, dimethyl acetate, methyl propionate, ethyl propionate, γ-butyrolactone, decanolide, γ-valerolactone, mevalonolactone, γ-caprolactone, δ-valerolactone, ε-caprolactone and the like.

Specific examples of the ether solvent include dibutyl ether, tetraglyme, 2-methyltetrahydrofuran, tetrahydrofuran and the like.

Specific examples of the ketone solvent include cyclohexanone and the like. Specific examples of the aromatic hydrocarbon organic solvent include benzene, fluorobenzene, chlorobenzene, iodobenzene, toluene, fluorotoluene, xylene and the like. Examples of the alkoxyalkane solvent include dimethoxy ethane, diethoxy ethane and the like.

Specific examples of the carbonate solvent include dimethylcarbonate (DMC), diethylcarbonate (DEC), dipropylcarbonate (DPC), methylpropylcarbonate (MPC), ethylpropylcarbonate (EPC), methylethylcarbonate (MEC), ethylmethylcarbonate (EMC), ethylene carbonate (EC), propylene carbonate (PC), butylenes carbonate (BC), fluoroethylene carbonate (FEC) and the like.

Of the aforementioned, it is preferable to use a carbonate solvent as the organic solvent, and of the aforementioned carbonate solvents, it may be more preferable to mix a carbonate organic solvent of a high dielectric constant having a high ion conductivity, capable of increasing the charging and discharging performance of the battery, with a carbonate organic solvent having a low viscosity, capable of appropriately adjusting the viscosity of the organic solvent of a high dielectric constant and use the same. Specifically, an organic solvent of a high dielectric constant being selected from a group consisting of ethylene carbonate, propylene carbonate and a mixture thereof, and an organic solvent of a low viscosity being selected from a group consisting of ethylmethyl carbonate, dimethyl carbonate, diethyl carbonate and a mixture thereof may be mixed and used. More preferably, it is better to mix the organic solvent of a high dielectric constant and the organic solvent of a low viscosity at a volume ratio of 2:8 to 8:2, and more specifically, it is possible to mix ethylene carbonate or propylene carbonate; ethylmethyl carbonate; and dimethylecarbonate or diethylecarbonate at a volume ratio of 5:1:1 to 2:5:3 and use the same, and preferably, at a volume ratio of 3:5:2 and use the same.

Any compound that can provide the lithium ion used in the lithium secondary battery 1 may be used as the lithium salt without particular limitations. Specifically, the lithium salt may be selected from a group consisting of LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂LiN(C₂F₅SO₂)₂, LiN(CF₃SO₂)₂, LiN(CₐF₂ₐ₊₁SO₂)(C_{b}F_{2b+1}SO₂)(but, a and b are natural numbers, preferably 1≦a≦20, and 1≦b≦20), LiCl, LiI, LiB(C₂O₄)₂ and a mixture thereof, and preferably, it is better to use lithium hexafluoro phosphate (LiPF₆).

When the lithium salt is dissolved in the electrolyte, the lithium salt may serve as a source of supply of lithium ions in the lithium secondary battery 1, and promote movement of lithium ions between the positive electrode 5 and the negative electrode 3. Accordingly, it is preferable that the lithium salt is included in the electrolyte at a concentration of about 0.6 mol % to 2 mol %. If the concentration of the lithium salt is less than 0.6 mol %, the conductivity of the electrolyte will decrease, and thus the performance of the electrolyte may deteriorate, and if the concentration of the lithium salt exceeds 2 mol %, the viscosity of the electrolyte will increase, and thus the mobility of the lithium ions may decrease. In consideration of such conductivity of the electrolyte and mobility of the lithium ions, it may be preferable that the lithium salt is adjusted within a range of about 0.7 mol % to 1.6 mol % in the electrolyte.

Besides the aforementioned elements of the electrolyte, the electrolyte may further include an additive (hereinafter, ‘other additives’) that may be used generally in electrolyte with a purpose to improve lifespan characteristics of the battery, inhibit reduction of battery capacity, improve discharge capacity of the battery and the like.

Specific examples of the other additives include vinylenecarbonate (VC), metal fluoride (for example, LiF, RbF, TiF, AgF, AgF2, BaF₂, CaF₂, CdF₂, FeF₂, HgF₂, Hg₂F₂, MnF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, InF₃, LaF₃, LuF₃, MnF₃, NdF₃, PrF₃, SbF₃, ScF₃, SmF₃, TbF₃, TiF₃, TmF₃, YF₃, YbF₃, TIF₃, CeF₄, GeF₄, HfF₄, SiF₄, SnF₄, TiF₄, VF₄, ZrF4₄, NbF₅, SbF₅, TaF₅, BiF₅, MoF₆, ReF₆, SF₆, WF₆, CoF₂, CoF₃, CrF₂, CsF, ErF₃, PF₃, PbF₃, PbF₄, ThF₄, TaF₅, SeF₆ and the like), glutaronitrile (GN), succinonitrile (SN), adiponitrile (AN), 3,3′-thiodipropionitrile (TPN), vinylethylene carbonate (VEC), fluoroethylene carbonate (FEC), difluoroethylenecarbonate, fluorodimethylcarbonate, fluoroethylmethylcarbonate, Lithium bis(oxalato)borate (LiBOB), Lithium difluoro (oxalate) borate (LiDFOB), Lithium (malonato oxalato) borate (LiMOB) and the like, or a mixture of solely one type or two or more types thereof. The aforementioned other additives may be included in 0.1 to 5 weight % of a total weight of the electrolyte.

The separator 7 used herein may be made of a common porous polymer film used in conventional separators, fabricated from a polyolefin polymer, such as for example, ethylene homopolymer, propylene homopolymer, ethylene/butene copolymer, ethylene/hexene copolymer, ethylene/methacrylate copolymer or the like, either solely or by depositing the same, or otherwise, a common porous non-woven fabric, for example, a non-woven fabric made of glass fiber of a high melting point, polyethylene terephthalate fiber and the like may be used, but there is no limitation thereto.

Meanwhile, the lithium secondary battery 1 may have a free space volume (EV) according to Equation 2 below with respect to a total volume of empty space inside the case 15 (CV) according to Equation 1 below, a free space volume (EV) of 0 to 45 volume %, preferably 5 to 30 volume %, and more preferably 5 to 25 volume %.

Volume of empty space inside the case (CV)=total volume inside the case (AV)−volume of electrode assembly (BV) [Equation 1]

Volume of free space (EV)=volume of empty space inside the case (CV)−volume of electrolyte (DV) [Equation 2]

In the aforementioned Equation 1, the volume of empty space inside the case 15 (CV) is the total volume inside the case 15 (AV) excluding the volume of electrode assembly 9 (BV), meaning the volume of space where the electrolyte may be injected. The volume of empty space inside the case 15 (CV) may be the volume of space excluding not only the volume of electrode assembly 9 (BV) but also a volume of a structure that occupies certain space inside the case 15, and the volume of empty space inside the case 15 (CV) may itself be the volume of space excluding the volume of a structure occupying certain space inside the case 15. One can know the volume of electrolyte (DV) based on the amount of electrolyte injected, but regarding an already fabricated battery, the volume of electrolyte (DV) may be measured based on the weight of electrolyte extracted through a centrifugal process, or by heating and evaporating the electrolyte and then converting into volume its difference of weight from before and after the heating.

The volume of free space (EV) is the volume of empty space inside the case 15 (CV) excluding the volume of electrolyte (DV), that is, the empty space remaining after injecting the electrolyte.

The volume of electrolyte (DV) may be 55 to 100 volume %, preferably 70 to 95 volume %, and more preferably 75 to 95 volume % of the total volume of empty space inside the case 15 (CV). More specifically, the volume of electrolyte (DV) may be 0.5 to 10 cm³.

As the lithium secondary battery 1 has the aforementioned volume of free space (EV) or the volume of free space (EV), it is possible to solve the problem where gas generated by oxidation reaction of the electrolyte due to high-voltage reduces reaction surface area of the electrode surface, and further increases side reaction, thereby accelerating degradation of capacity.

More specifically, when pressure is applied with the volume fixated, if gas is generated from inside, the volume of that gas becomes inversely proportional to the pressure. For example, if 10 ml of gas is generated under 1 kgf/cm², supposing that a same mass of gas is generated, under 2 kgf/cm², the volume of the gas will be 5 ml, that is, a ½ thereof. Such a principle is applied to the lithium secondary battery 1.

That is, in the case of the lithium secondary battery 1, the volume of free space (EV) inside the case 15 differs depending on the amount of electrolyte injected. When a large amount of electrolyte is injected, the volume of free space (EV) decreases, and when a small amount of electrolyte is injected, the volume of free space (EV) increases.

Further, in terms of structural characteristics of the lithium secondary battery 1, there is no problem in exhibiting the performance of the lithium secondary battery 1 if only the electrolyte is injected enough to submerge the positive electrode 5 and the negative electrode 3. Therefore, in the case of the lithium secondary battery 1 for high-voltage use, the mass of the gas generated by oxidation of electrolyte is the same between in the case where the electrolyte is injected only enough to submerge the positive electrode 5 and the negative electrode 3 and the case where the electrolyte is injected such that there is almost no volume of free space (EV) left.

Therefore, with the mass of gas generated during charging and discharging being the same, in the case where the volume of free space (EV) is large (the volume of electrolyte (DV) being small), there is a small increase of pressure caused by generation of gas. On the other hand, in the case where the volume of free space (EV) is small (the volume of electrolyte (DV) being large), the pressure caused by generation of gas increases.

Accordingly, there is an effect where the gas generated by oxidation reaction of the electrolyte in high-voltage is pressurized as the amount of electrolyte injected gets larger, thereby reducing the volume of gas generated accordingly. This means that the ratio at which the reaction surface area of a surface of the positive electrode 5 or the negative electrode 3 decreases is smaller than before the gas was pressurized, thereby reducing the speed of capacity degradation.

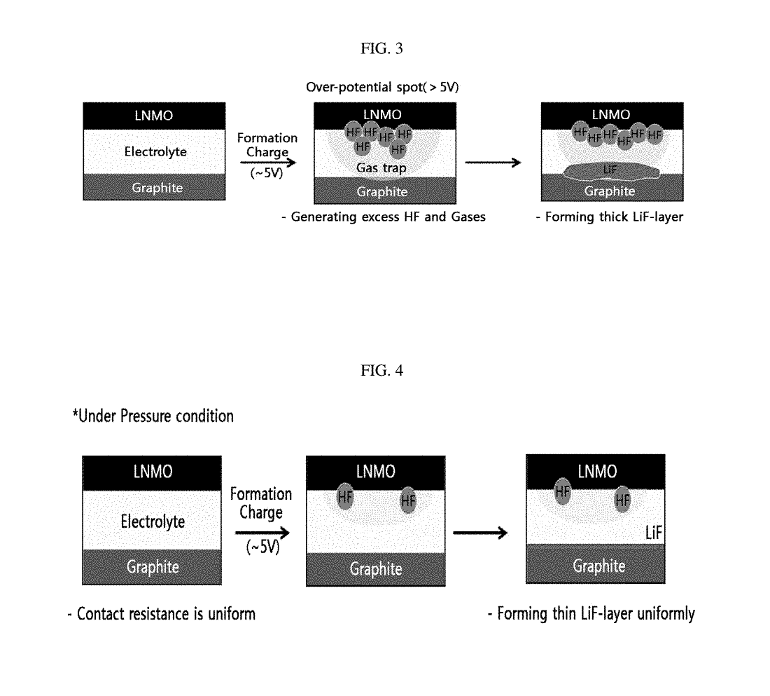

FIG. 3 is a view mimetically illustrating the capacity degradation caused by generation of gas in a conventional lithium secondary battery, and FIG. 4 is a view illustrating the principle where the speed of capacity degradation decreases in the case where the volume of free space (EV) is small as in the present disclosure. In FIGS. 3 and 4, ‘LNMO’ represents the positive electrode 5, ‘graphite’ represents the negative electrode 3, and ‘electrolyte’ represents the electrolyte.

Referring to FIG. 3, one can see that in a conventional lithium secondary battery, HF gas is generated during charging, and since the volume of the generated gas is large, it affects even to the reaction surface of the negative electrode 3, forming an nonuniform and thick surface coating layer (LiF) on the surface of the negative electrode 3, thereby causing capacity degradation. Especially, when an overvoltage is applied, such a tendency may be further intensified.

More specifically, as the electrolyte is oxidized by operation of the lithium secondary battery, gas such as H₂, CO, CO₂, C₃H₈, C₃H₆, C₂H₆, C₂H₂, and CH₄ may be generated, or due to moisture permeating inside the battery, lithium salt such as LiPF₆ included in the electrolyte may react with the moisture and generate HF_{gas}. In particular, LiF is formed at the positive electrode or negative electrode surface, especially at the negative electrode surface, due to HF, accelerating aging of the electrode surface, and this may lead to degradation of battery performance. Further, when the charging voltage, which depends on the type of negative electrode or positive electrode active material used in the lithium secondary battery, exceeds about 4V, the oxidation of electrolyte may be accelerated, thereby intensifying such degradation of battery performance.

Inventors of the present disclosure got the idea from the fact that by increasing the pressure inside a battery, the volume of the gas may be controlled, thereby reducing the surface area of reaction site on the electrode surface that the gas affects. That is, referring to FIG. 4, as the volume of free space (EV) decreases, any gas generated is pressurized, and thus its volume is reduced, and therefore, the gas cannot affect the negative electrode 3 surface, allowing the surface coating layer (LiF) to be formed uniformly and in a thin thickness, thereby reducing the speed of capacity degradation.

In a state where the lithium secondary battery 1 is charged by 1C and discharged by 1C at 25° C., and having the charging and discharging as 1 cycle, the cycle being iterated 100 times, the volume that the gas generated inside the lithium secondary battery 1 occupies (GV) under a condition of 25° C. and 1 kgf/cm² may be 1.5 to 15 times, preferably 2 to 10 times, and more preferably 3 to 10 times the volume of free space (EV). When the volume that the gas occupies (GV) under the condition of 25° C. and 1 kgf/cm² with respect to the volume of free space (EV) is within the aforementioned range, the generated gas cannot affect the negative electrode 3 surface, allowing the surface coating layer to be formed uniformly and in a thin thickness, thereby reducing the speed of capacity degradation.

In a state where the lithium secondary battery 1 is charged by 1C and discharged by 1C at 25° C., and having the charging and discharging as 1 cycle, the cycle being iterated 100 times, when the volume of free space (EV) is 0 to 45 volume %, the pressure inside the case 15 may be 1.5 to 15 times, preferably 2 to 12 times, and more preferably 3 to 10 times the pressure inside the case 15 when the volume of free space (EV) exceeds 45 volume %. That is, when the volume of free space (EV) is 0 to 45 volume %, the generated gas is pressurized, and thus cannot affect the negative electrode 3 surface, allowing the surface coating layer to be formed uniformly and in a thin thickness, thereby reducing the speed of capacity degradation.

In a state where the lithium secondary battery 1 is charged by 1C and discharged by 1C at 25° C., and having the charging and discharging as 1 cycle, the cycle being iterated 100 times, the pressure inside the case 15 may be 1 to 15 kgf/cm², preferably 5 to 15 kgf/cm², and more preferably 7 to 15 kgf/cm². When the pressure inside the case 15 is within the aforementioned range, the gas generated in the case 15 is pressurized, and thus cannot affect the negative electrode 3 surface, allowing the surface coating layer to be formed uniformly and in a thin thickness on the negative electrode 3 surface, thereby reducing the speed of capacity degradation.

The lithium secondary battery according to a specific embodiment of the present disclosure may have a current interrupt device (CID) in the cap assembly. Further, the current interrupt device operates under a condition where a current interrupt pressure is 13 kgf/cm² or more, which is where current flow to a safety vent is interrupted. In the present disclosure, the current interrupt device refers to an internal device of battery, configured to deform such as being broken or the like when the internal pressure of the battery reaches a predetermined current interrupt pressure, thereby interrupting the current flow of the battery.

In order to prevent the aforementioned side reaction of the electrode surface being caused by the side reaction generated by gas, and to prevent the capacity reduction rate from degrading significantly, the current interrupt pressure is set to at least 13 kgf/cm² or more, as aforementioned. If the operating pressure is set below 13 kgf/cm², controlling the gas volume inside the battery is not effective enough. Preferably, the current interrupt pressure is 14 kgf/cm² or more, or 15 kgf/cm² or more. Meanwhile, since the internal pressure of battery during gas generation may increase excessively and thus degrade stability, it is preferable that the current interrupt pressure of the current interrupt device is 20 kgf/cm² or less.

In the present disclosure, the current interrupt pressure needs to be set high within a possible range in order to increase the effect of reducing the volume of gas generated. Considering this fact, in an embodiment aspect of the present disclosure, the current interrupt pressure is set higher than the pressure inside the case 15 in a state where the lithium secondary battery 1 is charged by 1C and discharged by 1C at 25° C., and having the charging and discharging as 1 cycle, the cycle is iterated 100 times.

Further, in the present disclosure, when the current interrupt device (CID) has a short-circuit pressure of 13 kgf/cm² to 20 kgf/cm², and when fully charged and stored at a constant temperature condition of 75° C., short-circuit occurs for 600 hours or more.

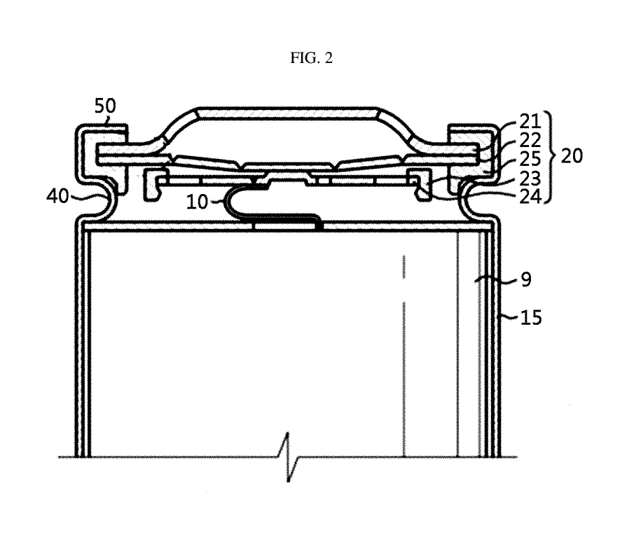

FIG. 2 is an enlarged view of the cap assembly according to a specific embodiment aspect of the present disclosure. The cap assembly 20 has a sequentially deposited structure of a top cap 21 that forms a positive electrode terminal, a safety vent 22 that interrupts current and/or exhausts gas when pressure inside the battery increases, an insulating member 23 that electrically separates the safety vent 22 from the current interrupt device 24 except for a certain portion, and the current interrupt device 24 to which a positive electrode lead 10 connected the positive electrode is jointed. Further, such a cap assembly 20 is mounted onto a beading unit 40 of the battery case 15 in a state where the cap assembly 20 is mounted onto a gasket 25. Therefore, under a normal operating condition, the positive electrode of the electrode assembly 9 is connected to the top cap 20 via the positive electrode lead 10, the current interrupt device 24 and the safety vent 22, thereby forming a current flow.

When a predetermined current interrupt pressure, for example, the aforementioned minimum interrupt pressure of 13 kgf/cm² is reached, the current interrupt device 24 may be broken and deviate from the safety vent, and accordingly the current flow will be interrupted. Although explained in detail in the present specification with reference to the drawings, there is no particular limitation to the exemplified disclosure, and thus one generally used in the related art may be used as long as it operates within the range of the aforementioned current interrupt pressure.

The positive electrode 5 may include at least one LNMO positive electrode active material selected from a group consisting of LiNi_{1-y}Mn_{y}O₂(O<y<1), LiMn_{2-z}Ni_{z}O₄(0<z<2) and a mixture thereof, and the negative electrode 3 may include a lithium titan oxide negative electrode active material. Further, the lithium secondary battery 1 may be a high-voltage lithium secondary battery 1 of a voltage of 3V or more, and preferably 5V or more. In the case where the positive electrode 5 includes an LMNO positive electrode active material, and the negative electrode 3 includes a lithium titan oxide negative active material, when the lithium secondary battery 1 operates at high-voltage, the effect of the present disclosure may be maximized.

The lithium secondary battery 1 may be fabricated in a common method, and thus in the present specification, detailed explanation thereof will be omitted. In the present embodiment, a cylindrical-type lithium secondary battery 1 was explained as an example, but the technology of the present disclosure is not limited to the cylindrical-type lithium secondary battery 1, but any form is possible as long as it can operate as a battery.

### FABRICATED EXAMPLE

### Fabricating Negative Electrode Using Negative Electrode Protection

### Example 1

By mixing graphite, a carbon black conductive material, and a PVdF binder in an N-methylpyrrolidone solvent, a composition for forming a negative electrode active material layer was fabricated, and then the composition was applied to a copper current collector, forming a negative electrode active material layer.

By mixing an LNMO positive electrode active material, a carbon black conductive material, and a PVdF binder in an N-methylpyrrolidone solvent, a composition for forming a positive electrode active material layer was fabricated, and then the composition was applied to an aluminum current collector, forming a positive electrode active material layer.

By interposing a separator of porous polyethylene between the positive electrode and graphite negative electrode fabricated as aforementioned, an electrode assembly was fabricated, and by disposing the electrode assembly inside the case, and injecting electrolyte until the volume of free space (EV) with respect to the total volume of empty space inside the case (CV) becomes 20 volume %, a lithium secondary battery was fabricated.

### Comparative Example 1

A lithium secondary battery was fabricated by implementing the Example 1 in the same manner except that the electrolyte was injected until the volume of free space (EV) with respect to the total volume of empty space inside the case (CV) became 46 volume %.

### EXPERIMENTAL EXAMPLES

### Measuring Performance of Lithium Secondary Battery Fabricated

### Experimental Example 1

### Measuring Physical Properties of Lithium Secondary Battery Fabricated

The lithium secondary battery fabricated in the embodiment had a volume of free space (EV) that is 20 volume % with respect to the total volume of empty space inside the case (CV), and a volume of 80 volume % with respect to the total volume of empty space inside the case (CV), and in a state where the lithium secondary battery is charged by 1C and discharged by 1C at 25° C., and having the charging and discharging as 1 cycle, the cycle is iterated 100 times, the volume that the gas generated inside the lithium secondary battery occupies (GV) under a condition of 25° C. and 1 kgf/cm² was 6 times the volume of free space (EV), and the pressure inside the case was 6 kgf/cm².

The lithium secondary battery fabricated in the above Comparative Example had a volume of free space (EV) that is 46 volume % with respect to the total volume of empty space inside the case (CV), and a volume of 56 volume % with respect to the total volume of empty space inside the case (CV), and in a state where the lithium secondary battery is charged by 1C and discharged by 1C at25° C., and having the charging and discharging as 1 cycle, the cycle is iterated 100 times, the volume that the gas generated inside the lithium secondary battery occupies (GV) under a condition of 25° C. and 1 kgf/cm² was 10 times the parts by volume of the 100 parts by volume of the free space (EV), and the pressure inside the case was 10 kgf/cm².

### Experimental Example 2

### Measuring Lifespan Characteristics

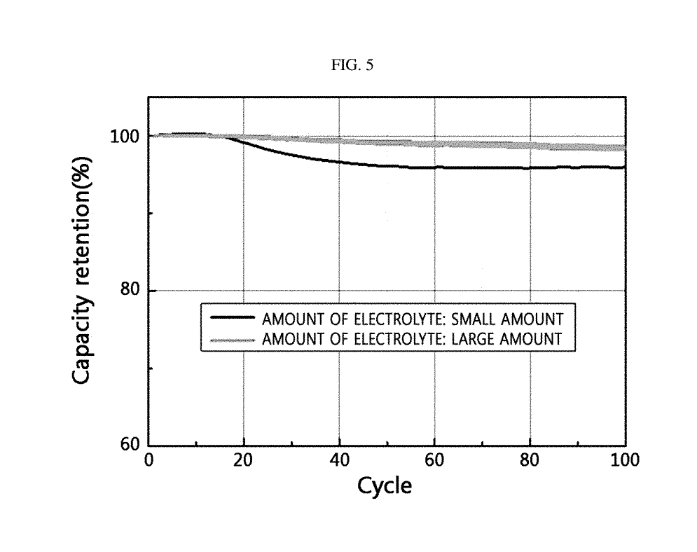

Lifespan characteristics of battery of the lithium secondary battery fabricated in the above Example and the Comparative Example were measured. 100 cycles of charging and discharging were carried out under a condition of 1C/1C charging/discharging condition at 25° C., measurements were made twice for each case, and the results were listed in FIG. 4. In FIG. 5, the Example indicates when there is a large amount of electrolyte, and the Comparative Example indicates when there is a small amount of electrolyte.

Referring to FIG. 5, one can see that, when compared to the lithium secondary battery fabricated in the Comparative Example, the lithium secondary battery fabricated in the Example has reduced capacity degradation, thereby improved lifespan characteristics.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

### DESCRIPTION OF REFERENCE NUMERALS

1: LITHIUM SECONDARY BATTERY 3: NEGATIVE ELECTRODE

5: POSITIVE ELECTRODE 7: SEPARATOR

9: ELECTRODE ASSEMBLY 10, 13: LEAD MEMBER

15: CASE 20: CAP ASSEMBLY

21: TOP CAP 22: SAFETY VENT

23: INSULATING MEMBER 24: CURRENT INTERRUPT DEVICE

25: GASKET 40: BEADING UNIT

50: CRIMPING PORTION

What is claimed is:

1. An electrochemical device comprising:
a case, an electrode assembly disposed inside the case, and including a positive electrode and a negative electrode and a separator interposed between the positive electrode and the negative electrode,
a cap assembly coupled to an open top end of the case and provided with a current interrupt device (CID), and an electrolyte injected inside the case, wherein the negative electrode includes a carbon material as a negative electrode active material, and
a free space volume (EV) according to Equation 2 below with respect to a total volume of empty space inside the case (CV) according to Equation 1 below is 0 to 45 volume %.
Volume of empty space inside the case (CV)=total volume inside the case (AV)−volume of electrode assembly (BV) [Equation 1]
Volume of free space (EV)=volume of empty space inside the case (CV)−volume of electrolyte (DV) [Equation 2]

2. The electrochemical device of claim 1, wherein the electrochemical device is a cylindrical-type electrochemical device.

3. The electrochemical device of claim 1, wherein the volume of free space (EV) with respect to the total volume of empty space inside the case (CV) is 5 to 30 volume %.

4. The electrochemical device of claim 1, wherein the volume of the electrolyte (DV) is 55 to 100 volume % with respect to the total volume of empty space inside the case (CV).

5. The electrochemical device of claim 1, wherein the volume of the electrolyte (DV) is 0.5 to 10 cm³.

6. The electrochemical device of claim 1, wherein, in a state where the electrochemical device is charged by 1C and discharged by 1C at 25° C., and having the charging and discharging as 1 cycle, the cycle is iterated 100 times, when the volume of free space (EV) is 0 to 45 volume % or more, a pressure inside the case is 1.5 to 15 times the pressure inside the case when the volume of free space (EV) exceeds 45 volume %.

7. The electrochemical device of claim 1, wherein, in a state where the electrochemical device is charged by 1C and discharged by 1C at 25° C., and having the charging and discharging as 1 cycle, the cycle is iterated 100 times, a pressure inside the case is 1 to 15 kgf/cm².

8. The electrochemical device of claim 1, wherein the positive electrode includes any one positive electrode active material selected from a group consisting of LiNi_{1-y}Mn_{y}O₂(O<y<1), LiMn_{2-z}Ni_{z}O₄(0<z<2) and a mixture thereof.

9. The electrochemical device of claim 1, wherein the electrochemical device is a high-voltage electrochemical device of 3V or more.

10. The electrochemical device of claim 1, wherein the electrochemical device is a lithium secondary battery.

11. The electrochemical device of claim 1, wherein the CID has a short-circuit pressure of 13 kgf/cm² to 20 kgf/cm².

12. The electrochemical device of claim 1, wherein the CID has a short-circuit pressure of 13 kgf/cm² to 20 kgf/cm², and when fully charged and stored at a constant temperature condition of 75° C., short-circuit occurs for 600 hours or more.

13. The electrochemical device of claim 11, wherein the current interrupt device (CID) has a short-circuit pressure of 13 kgf/cm² to 20 kgf/cm², and of the range, the short-circuit pressure is set higher than an inner pressure in a state where when the electrochemical device is charged by 1C and discharged by 1C at 25° C., and having the charging and discharging as 1 cycle, the cycle is iterated 100 times.
